(19) United States
(12) Patent Application Publication
(10) Pub. No.: US 2025/0325041 A1
(43) Pub. Date: Oct. 23, 2025

(54) AEROSOL GENERATING DEVICE AND SYSTEM

(71) Applicant: JT INTERNATIONAL SA, Geneva (CH)

(72) Inventors: Hajime FUJITA, Geneva (CH); Grzegorz Aleksander PILATOWICZ, Grens (CH); Eduardo Jose GARCIA GARCIA, Grand-Saconnex (CH)

(73) Assignee: JT INTERNATIONAL SA, Geneva (CH)

(21) Appl. No.: 18/870,465

(22) PCT Filed: May 16, 2023
(86) PCT No.: PCT/EP2023/063092

§ 371 Date: Nov. 29, 2024

(30) Foreign Application Priority Data
May 30, 2022 (EP) 22176175.2

(51) Int. Cl. A24F 40/57; A24F 40/465; H05B 6/08; H05B 6/10

(52) U.S. Cl. CPC A24F 40/57; A24F 40/465; H05B 6/08; H05B 6/105

(57) ABSTRACT

An aerosol generating device includes a power source and an oscillating circuit configured to generate a time varying electromagnetic field for inductively heating a susceptor. A frequency generating circuit of a controller comprises a variable frequency oscillator VFO including a supply voltage terminal configured to receive a regulated supply voltage, a set terminal, and an oscillator output terminal configured to provide an output signal having a frequency that is determined by the resistance between the supply voltage terminal and the set terminal. The frequency generating circuit also includes a switching circuit electrically connected to the power source and configured to drive the oscillating circuit at an operating frequency determined by the frequency of the output signal of the VFO. A variable resistive component such as a thermistor is electrically connected between the supply voltage terminal and the set terminal of the VFO.

### TECHNICAL FIELD

The present disclosure relates generally to an aerosol generating device, and more particularly to an aerosol generating device for generating an aerosol for inhalation by a user. Embodiments of the present disclosure also relate to an aerosol generating system that includes an aerosol generating device, and an aerosol generating article comprising a susceptor and aerosol generating material.

The present disclosure also relates generally to a method for controlling the heating of a susceptor of an aerosol generating system.

The present disclosure is particularly applicable to a portable (hand-held) aerosol generating device. Such devices heat, rather than burn, an aerosol generating material or substrate, e.g., tobacco or other suitable materials, by conduction, convention, and/or radiation to generate an aerosol for inhalation by a user. The present disclosure is particularly concerned with an inductively heated aerosol generating device.

### TECHNICAL BACKGROUND

Devices which heat, rather than burn, an aerosol generating material to produce an aerosol for inhalation have become popular with consumers in recent years. A commonly available reduced-risk or modified-risk device is the heated material aerosol generating device, or so-called heat-not-burn device. Devices of this type generate an aerosol or vapour by heating an aerosol generating material to a temperature typically in the range 150° C. to 300° C. Heating the aerosol generating material to a temperature within this range, without burning or combusting the aerosol generating material, generates a vapour which typically cools and condenses to form an aerosol for inhalation by a user of the device.

Such devices may use one of a number of different approaches to provide heat to the aerosol generating material. One such approach is to provide an aerosol generating device which employs an induction heating system and into which an aerosol generating article, comprising aerosol generating material, can be removably inserted by a user. In such a device, an induction coil is provided with the device and an induction heatable susceptor is provided with the aerosol generating article. Electrical energy is provided to the induction coil when a user activates the device which in turn generates an alternating electromagnetic field. The susceptor couples with the electromagnetic field and generates heat, which is transferred, for example by conduction, to the aerosol generating material and an aerosol is generated as the aerosol generating material is heated.

It is generally desirable to control the heating of the aerosol generating material to ensure that an aerosol with acceptable characteristics is generated for inhalation by a user throughout a period of use (also known as a vaping session). Embodiments of the present disclosure seek to provide an improved user experience in which the characteristics of the generated aerosol are optimised through more accurate control of the heating of the aerosol generating material by the susceptor.

### SUMMARY OF THE DISCLOSURE

According to a first aspect of the present disclosure, there is provided an aerosol generating device comprising:
a power source, e.g., a battery or cell;
an oscillating circuit configured to generate a time varying electromagnetic field for inductively heating a susceptor; and
a frequency generating circuit comprising:
   a variable frequency oscillator (VFO) comprising:
      a supply voltage terminal configured to receive a supply voltage:
      a set terminal; and
      an oscillator output terminal configured to provide an output signal having a frequency that is determined by an input signal into the set terminal:
   a switching circuit electrically connected to the power source and configured to drive the oscillating circuit at an operating frequency determined by the frequency of the output signal of the VFO; and
   a variable resistive component electrically connected to the set terminal of the VFO.

The susceptor is an induction heatable susceptor and may be part of an aerosol generating article that also includes aerosol generating material and which is removably insertable into the device.

The oscillating circuit may comprise a capacitor and an induction coil that are arranged to generate a time varying electromagnetic field for inductively heating the susceptor.

The susceptor and the oscillating circuit may define a parallel RLC circuit with a resonant frequency fₒ that depends on the values of resistance R, capacitance C, and inductance L, e.g., where:

$${f}_{0} = \frac{1}{2 π} \sqrt{\frac{1}{LC} - {( \frac{R}{L} )}^{2}}$$

The resistance R of the parallel RLC circuit depends on the exact positioning of the susceptor with respect to the induction coil and on the resistance of the susceptor, which varies with temperature. This means that the resonant frequency of the parallel RLC circuit will vary over the course of a vaping session as the temperature of the susceptor changes. For most efficient heating, the oscillating circuit is preferably driven at an operating frequency that substantially matches the resonant frequency. Providing more efficient heating may lead to an improvement in aerosol generation. The device according to the present disclosure therefore aims to adjust the operating frequency to match the changing resonant frequency of the parallel RLC circuit to provide improved heating and a better user experience. The device uses a frequency generating circuit that has a simple design, is robust and cost-effective to implement. This in turn allows for a more compact, efficient and lightweight aerosol generating device.

The VFO may be an integrated circuit (IC) device, for example.

The input signal that is provided to the set terminal of the VFO may be the resistance between the supply voltage terminal and the set terminal. The frequency of the output signal of the VFO may be determined by the resistance between the supply voltage terminal and the set terminal. The variable resistive component may be electrically connected between the supply voltage terminal and the set terminal of the VFO.

The VFO may directly relate the frequency f_{osc} of the output signal to the resistance Rₛₑₜ between the supply voltage terminal and the set terminal that is determined by the variable resistance component, e.g., where:

$${f}_{osc} = 10 MHz \cdot ( \frac{10 k}{N \cdot {R}_{set}} )$$

and where N may be selected to be 100, 10 or 1 depending on the frequency range required.

The switching circuit may include one or more semiconductor switches, for example, which are controlled to switch at the operating frequency that is determined by the selectable frequency of the output signal of the VFO. The switching circuit drives the oscillating circuit at the operating frequency to generate an alternating electromagnetic field at the same frequency for heating the susceptor. The switching circuit may be configured to operate at a frequency of between approximately 80 KHz and 500 kHz, possibly between approximately 150 kHz and 250 kHz, and possibly at approximately 200 kHz. The switching circuit may be configured to operate at a higher frequency, for example in the MHz range, depending on the type of inductively heatable susceptor that is used. The frequency range of the output signal of the VFO may be selected accordingly. The switching circuit may be an inverter.

The device may further comprise a voltage regulator, e.g., a low-dropout regulator (LDO). The voltage regulator may be electrically connected to the power source and include a voltage regulator output terminal configured to provide a regulated supply voltage. The supply voltage terminal of the VFO may be electrically connected to the voltage regulator output terminal so that the VFO receives a regulated supply voltage. The regulated supply voltage may be supplied to other components such as the digital potentiometer and the divider mentioned below. Using a regulated supply voltage may provide stable operation of the frequency generating circuit and other components.

In one embodiment, the variable resistive component may be a thermistor whose internal resistance that varies with temperature. The thermistor may be placed close to the susceptor and/or the aerosol generating material in use. For example, the thermistor may be arranged adjacent to, or inside, a part of the device such as a heating chamber or aerosol generating space that is adapted to receive an aerosol generating article that includes the susceptor and the aerosol generating material. The thermistor may be mounted on a surface of the heating chamber or aerosol generating space such as an inner sidewall or bottom wall of the heating chamber or aerosol generating space, for example. The thermistor may also be arranged in the aerosol generating article and in electrical contact with the VFO when the article is inserted into the device. The thermistor may be in direct contact with the susceptor or the aerosol generating material. As the temperature of the susceptor varies, the internal resistance of the closely located thermistor will vary accordingly. The thermistor may be selected so that its internal resistance varies appropriately as a function of temperature. In one embodiment, for example, the thermistor may have a negative temperature coefficient (NTC) where its resistance decreases with increasing temperature and vice versa. The resistance of the thermistor may vary linearly or non-linearly with temperature.

Because the frequency of the output signal of the VFO is determined by the resistance between the supply voltage terminal and the set terminal, i.e., the terminals to which the thermistor is electrically connected, it means that any change in the internal resistance of the thermistor will automatically result in a corresponding change in the frequency of the output signal of the VFO, and consequently in the operating frequency at which the switching circuit drives the oscillating circuit. In particular, the thermistor may be selected and located relative to the susceptor so that a change in the temperature of the susceptor, which results in a change in the resonant frequency of the parallel RLC circuit, also results in a change in its internal resistance, which in results in turn in a corresponding change in the operating frequency generated by the frequency generating circuit. The operating frequency may therefore be made to track changes in the resonant frequency of the parallel RLC circuit so that the device operates at optimum efficiency.

The device may further comprise a control unit or processor, e.g., a microcontroller unit or microprocessor unit.

The variable resistive component may be a digital potentiometer having a resistance that is selectively varied by the control unit. The digital potentiometer may comprise a first potentiometer terminal electrically connected to the set terminal of the VFO, a second potentiometer terminal electrically connected to the supply voltage terminal of the VFO, and at least one data terminal configured to receive command data from the control unit for selectively varying the resistance of the digital potentiometer. The control unit may be configured to vary the resistance of the digital potentiometer based on an estimated or determined impedance value of the parallel RLC circuit. In particular, the device may further comprise a voltage sensor configured to provide voltage measurements and a current sensor configured to provide current measurements. The voltage and current measurements may be used to estimate or determine the impedance value. In these embodiments, the control unit may control the digital potentiometer so that the frequency of the output signal of the VFO is changed in response to changes in the resonant frequency of the oscillating circuit.

The control unit may be configured to receive the voltage and current measurements provided by the voltage and current sensors and to use the voltage and current measurements to estimate or determine the impedance value. The device may also comprise a divider configured to receive the voltage and current measurements provided by the voltage and current sensors. The divider may output an impedance value to the control unit that is estimated or determined using the voltage and current measurements. A first low pass filter may be connected between the voltage sensor and the divider. A second low pass filter connected between the current sensor and the divider.

An increase in the impedance value may indicate an increase in the resonant frequency of the parallel RLC circuit and vice versa. The control unit may contain an appropriate control scheme which derives command data for selectively varying the resistance of the digital potentiometer based on the change in the impedance value. In particular, if the impedance value changes, indicating a change in the resonant frequency of the parallel RLC circuit, the command data will vary the resistance of the digital potentiometer accordingly. Because the frequency of the output signal of the VFO is determined by the resistance between the supply voltage terminal and the set terminal, i.e., the terminals to which the digital potentiometer is electrically connected, it means that any change in the resistance of the digital potentiometer will automatically result in a corresponding change in the frequency of the output signal of the VFO, and consequently in the operating frequency at which the switching circuit drives the oscillating circuit. In particular, the control scheme of the control unit may be selected so that a change in the impedance value as a result of a change in the temperature of the susceptor, and which is indicative of a change in the resonant frequency of the RLC circuit, results in a change in the selected resistance of the digital potentiometer which results in turn in a corresponding change in the operating frequency generated by the frequency generating circuit. The operating frequency may therefore be made to track changes in the resonant frequency of the parallel RLC circuit so that the device operates at optimum efficiency. Such operation of the device may result in improved aerosol generation.

According to a second aspect of the present disclosure, there is provided an aerosol generating device as described herein, being configured to receive, in use, an aerosol generating article comprising a susceptor and aerosol generating material.

According to a third aspect of the present disclosure, there is provided an aerosol generating system for generating an aerosol for inhalation by a user, the system comprising an aerosol generating device as described herein, and an aerosol generating article comprising a susceptor and aerosol generating material.

The aerosol generating system is adapted to heat the aerosol generating material, without burning the aerosol generating material, to volatise at least one component of the aerosol generating material and thereby generate an aerosol for inhalation by a user of the aerosol generating system.

In general terms, a vapour is a substance in the gas phase at a temperature lower than its critical temperature, which means that the vapour may be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The induction coil may comprise a Litz wire or a Litz cable. It will, however, be understood that other materials could be used. The induction coil may be substantially helical in shape and may, for example, extend around the space in which the aerosol generating article is received in use.

The circular cross-section of a helical induction coil may facilitate the insertion of the aerosol generating article into the aerosol generating device, for example into the space in which the aerosol generating article is received in use, and may ensure uniform heating of the aerosol generating material.

The induction heatable susceptor may comprise one or more, but not limited, of aluminium, iron, nickel, stainless steel and alloys thereof, e.g. Nickel Chromium or Nickel Copper. With the application of an electromagnetic field in its vicinity, the susceptor may generate heat due to eddy currents and magnetic hysteresis losses resulting in a conversion of energy from electromagnetic to heat.

The induction coil may be arranged to operate in use with a fluctuating electromagnetic field having a magnetic flux density of between approximately 20 mT and approximately 2.0T at the point of highest concentration.

The aerosol generating material may be any type of solid or semi-solid material. Example types of aerosol generating solids include powder, granules, pellets, shreds, strands, particles, gel, strips, loose leaves, cut filler, porous material, foam material or sheets. The aerosol generating material may comprise plant derived material and in particular, may comprise tobacco. Upon being heated by the susceptor, the aerosol generating material may release volatile compounds. The volatile compounds may include nicotine or flavour compounds such as tobacco flavouring.

The foam material may comprise a plurality of fine particles (e.g. tobacco particles) and may also comprise a volume of water and/or a moisture additive, such as a humectant. The foam material may be porous, and may allow a flow of air and/or vapour through the foam material.

The aerosol generating material may comprise an aerosol-former. Examples of aerosol-formers include polyhydric alcohols and mixtures thereof such as glycerine or propylene glycol. Typically, the aerosol generating material may comprise an aerosol-former content of between approximately 5% and approximately 50% on a dry weight basis. In some embodiments, the aerosol generating material may comprise an aerosol-former content of between approximately 10% and approximately 20% on a dry weight basis, and possibly approximately 15% on a dry weight basis.

The aerosol generating article may comprise an air-permeable shell containing aerosol generating material. The air permeable shell may comprise an air permeable material which is electrically insulating and non-magnetic. The material may have a high air permeability to allow air to flow through the material with a resistance to high temperatures. Examples of suitable air permeable materials include cellulose fibres, paper, cotton and silk. The air permeable material may also act as a filter. Alternatively, the aerosol generating article may comprise an aerosol generating substance wrapped in paper. Alternatively, the aerosol generating material may be contained inside a material that is not air permeable, but which comprises appropriate perforations or openings to allow air flow. The aerosol generating material may be formed substantially in the shape of a stick, and may broadly resemble a cigarette, having a tubular region with an aerosol generating material arranged in a suitable manner. The aerosol generating article may include a filter segment, for example comprising cellulose acetate fibres, at a proximal end of the aerosol generating article. The filter segment may constitute a mouthpiece filter and may be in coaxial alignment with the aerosol generating material. One or more vapour collection regions, cooling regions, and other structures may also be included in some designs. For example, the aerosol generating article may include at least one tubular segment upstream of the filter segment. The tubular segment may act as a vapour cooling region. The vapour cooling region may advantageously allow the heated vapour generated by heating the aerosol generating material to cool and condense to form an aerosol with suitable characteristics for inhalation by a user, for example through the filter segment.

According to a fourth aspect of the present disclosure there is provided a method for controlling the heating of a susceptor of an aerosol generating system for generating an aerosol for inhalation by a user, the system comprising:
a power source;
an oscillating circuit configured to generate a time varying electromagnetic field for inductively heating the susceptor; and
a frequency generating circuit comprising a VFO, a switching circuit electrically connected to the power source, and a variable resistive component;
the method comprising controlling the VFO to provide an output signal having a frequency that is determined by the resistance of the variable resistance component and driving the oscillating circuit at an operating frequency determined by the frequency of the output signal of the VFO.

As described above, the variable resistive component may be a thermistor having an internal resistance that varies with temperature or a digital potentiometer having a resistance that is selectively varied, e.g., by a control unit.

### BRIEF DESCRIPTION OF THE DRAWINGS

FIG. 1 is a diagrammatic view of an example of an aerosol generating system:

FIG. 2 is a schematic representation of a first example of a controller of the aerosol generating system of FIG. 1; and

FIG. 3 is a schematic representation of a second example of a controller of the aerosol generating system of FIG. 1.

### DETAILED DESCRIPTION OF EMBODIMENTS

Embodiments of the present disclosure will now be described by way of example only and with reference to the accompanying drawings.

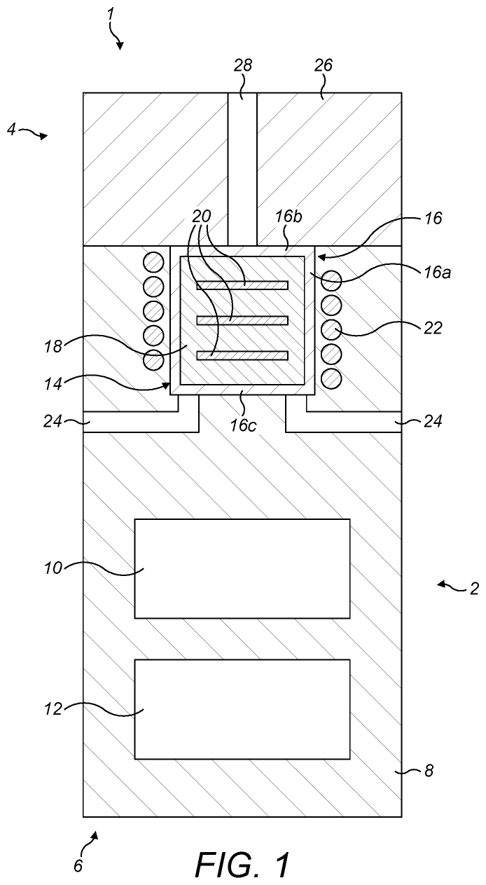

Referring initially to FIG. 1, there is shown diagrammatically an example of an aerosol generating system 1. The aerosol generating system 1 comprises an aerosol generating device 2 and an aerosol generating article 16. The aerosol generating device 2 has a proximal end 4 and a distal end 6 and comprises a device body 8 which includes a power source 10 and a controller 12 which may be configured to operate at high frequency. The power source 10 typically comprises one or more batteries which could, for example, be inductively rechargeable. The controller 12 typically includes one or more microcontroller units (MCUs) or microprocessor units (MPUs).

The aerosol generating device 2 is generally cylindrical and comprises a generally cylindrical aerosol generating space 14, for example in the form of a heating chamber or compartment, at the proximal end 4 of the aerosol generating device 2. The cylindrical aerosol generating space 14 is arranged to receive a correspondingly shaped generally cylindrical aerosol generating article 16 containing an aerosol generating material 18 and one or more induction heatable susceptors 20. The aerosol generating article 16 typically comprises a non-metallic cylindrical outer shell 16a and an air-permeable layer or membrane 16b, 16c at the proximal and distal ends to contain the aerosol generating material 18 and allow air to flow through the aerosol generating article 16. The aerosol generating article 16 is a disposable article which may, for example, contain tobacco as the aerosol generating material 18.

The aerosol generating device 2 comprises a helical induction coil 22 which has a circular cross-section, and which extends around the cylindrical aerosol generating space 14. The induction coil 22 may be energised by the power source 10 and controller 12. As described in more detail below, the controller 12 includes, amongst other electronic components, a switching circuit (e.g., an inverter) which is arranged to convert a direct current from the power source 10 into an alternating high-frequency current for the induction coil 22.

The aerosol generating device 2 includes one or more air inlets 24 in the device body 8 which allow ambient air to flow into the aerosol generating space 14. The aerosol generating device 2 also includes a mouthpiece 26 having an air outlet 28. The mouthpiece 26 is removably mounted on the device body 8 at the proximal end 4 to allow access to the aerosol generating space 14 for the purposes of inserting or removing an aerosol generating article 16.

As will be understood by one of ordinary skill in the art, when the induction coil 22 is energised during use of the aerosol generating system 1, an alternating and time-varying electromagnetic field is produced. This couples with the one or more induction heatable susceptors 20 and generates eddy currents and/or magnetic hysteresis losses in the one or more induction heatable susceptors causing them to heat up. The heat is then transferred from the one or more induction heatable susceptors 20 to the aerosol generating material 18, for example by conduction, radiation and convection.

The induction heatable susceptor(s) 20 may be in direct or indirect contact with the aerosol generating material 18, such that when the susceptor(s) is/are inductively heated by the induction coil 22, heat is transferred from the susceptor(s) to the aerosol generating material, to heat the aerosol generating material and thereby produce an aerosol. The susceptor(s) 20 may have any suitable shape and configuration, e.g., planar shape, particle shape, or a combination thereof. The aerosolisation of the aerosol generating material 18 is facilitated by the addition of air from the surrounding environment through the air inlets 24. The aerosol generated by heating the aerosol generating material 18 exits the aerosol generating space 14 through the air outlet 28 where it can be inhaled by a user of the device 2. The flow of air through the aerosol generating space 14, i.e. from the air inlets 24, through the aerosol generating space and out of the air outlet 28, can be aided by negative pressure created by a user drawing air from the air outlet side of the device 2.

The induction coil 22 forms part of an oscillating circuit. The oscillating circuit also includes a capacitor. A parallel RLC circuit includes the induction coil 22, the capacitor and the induction heatable susceptor(s) 20 of the aerosol generating article 16 and has a resonant frequency which varies during operation of the aerosol generating system 1 as a result of change in the temperature of the susceptor(s) 20.

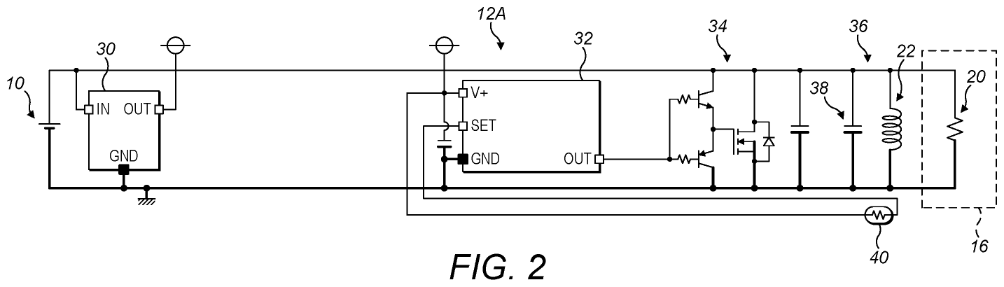

A first example of a controller 12A is illustrated in FIG. 2. The controller 12A includes a low-dropout (LDO) regulator 30 electrically connected to the power source 10. The LDO includes an input terminal (labelled “IN”) that is connected to the power source 10 and an output terminal (labelled “OUT”) that provides a regulated voltage supply. A ground terminal (labelled “GND”) is electrically connected to ground.

The controller 12A includes an integrated circuit (IC) variable frequency oscillator (VFO) 32. The VFO may be implemented using an LTC®1799 from Analog Devices, One Analog Way, Wilmington, MA 01887, United States of America, for example. The LTC®1799 is a precision oscillator with an oscillator frequency that is selected by an external resistance. The VFO 32 includes a supply voltage terminal (labelled “V+”) which is electrically connected to the output terminal of the VDO 30 and configured to receive a regulated supply voltage (e.g., 2.7 to 5.5 V). The VFO 32 also includes a set terminal (labelled “SET”) and an oscillator output terminal (labelled “OUT”) for providing an output signal (e.g., a square wave signal) having a frequency that is determined by the external resistance (Rₛₑₜ) between the supply voltage terminal and the set terminal. In particular, the oscillator frequency f_{osc} is determined by:

$${f}_{osc} = 10 MHz \cdot ( \frac{10 k}{N \cdot {R}_{set}} )$$

where N may be selected to be 100, 10 or 1 depending on the frequency range required. In practice, this can be done by electrically connecting a dividing terminal of the VFO (not shown) to one of the regulated supply voltage, open voltage, and ground. The oscillator frequency can be in the range 1 kHz to 33 MHz.

It can be seen from the above equation that if the external resistance Rₛₑₜ increases, the oscillator frequency f_{osc} will decrease and vice versa.

The VFO 32 also includes a ground terminal (labelled “GND”) which is electrically connected to ground.

A switching circuit 34 is electrically connected to the power source 10 and is configured to drive an oscillating circuit 36 at an operating frequency that is determined by the oscillator frequency. The oscillating circuit 36 includes a capacitor 38 and an induction coil 22. A parallel RLC circuit includes the capacitor 38, the induction coil 22 and one or more induction heatable susceptors 20, which are part of the aerosol generating article 16.

In the first controller 12A shown in FIG. 2, a thermistor 40 is electrically connected between the supply voltage terminals and the set terminal of the VFO 32. The internal resistance of the thermistor 40 varies with temperature and determines the external resistance Rₛₑₜ. Consequently, any change in the internal resistance of the thermistor 40 automatically results in a change in the oscillator frequency f_{osc} and hence in the frequency at which the oscillating circuit 36 is driven by the switching circuit 34. The thermistor 40 may be arranged adjacent to, or inside, the aerosol generating space 14 shown in FIG. 1, for example, where it will experience similar temperature changes to those experienced by the susceptor(s) 20 during operation of the aerosol generating system 1, and in particular during heating of the aerosol generating material 18. As the temperature of the susceptor(s) varies, the internal resistance of the thermistor 40 will vary accordingly. The thermistor 40 is selected so that its internal resistance decreases in response to an increasing temperature and vice versa. If the resonant frequency of the parallel RLC circuit increases because of an increase in the temperature of the susceptor(s) 22, the internal resistance of the thermistor 40 will decrease. The external resistance Rₛₑₜ electrically connected between the supply voltage terminal and the set terminal of the VFO 32 will therefore also decrease, and the oscillator frequency f_{osc} will increase. On the other hand, if the resonant frequency of the parallel RLC circuit decreases because of a decrease in the temperature of the susceptor(s) 22, the internal resistance of the thermistor 40 will increase. The external resistance Rₛₑₜ electrically connected between the supply voltage terminal and the set terminal of the VFO 32 will therefore also increase, and the oscillator frequency f_{osc} will decrease. The oscillator frequency may therefore track the resonant frequency of the parallel RLC circuit without the need for any additional sensors. The thermistor 40 may be selected so that the change in the oscillator frequency f_{osc} as a result of the change in its internal resistance substantially matches the change in the resonant frequency of the parallel RLC circuit, i.e., so that the oscillator frequency and the resonant frequency remain substantially matched even when the temperature of the susceptor(s) 20 changes.

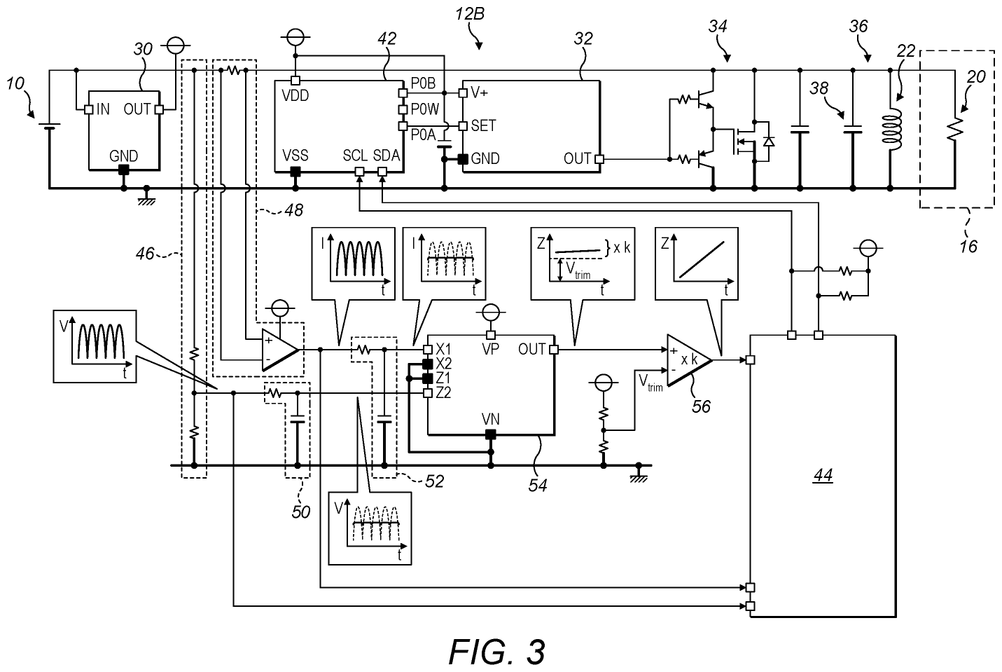

FIG. 3 shows an alternative controller 12B where like components have been given the same reference sign. In the second controller 12B, a digital potentiometer 42 is electrically connected between the supply voltage terminals and the set terminal of the VFO 32. The digital potentiometer 42 may be implemented using an MCP483X from Microchip Technology Inc., 2355 West Chandler Blvd., Chandler, Arizona, United States of America, for example. The MCP453X device is a single channel, volatile, 7-bit (129 wiper steps) digital potentiometer with an I²C compatible interface. The digital potentiometer 42 includes a supply voltage terminal (labelled “VDD”) which is electrically connected to the output terminal of the VDO 30 and configured to receive the same regulated supply voltage as the VFO 32. The digital potentiometer 42 also includes a first potentiometer terminal (labelled “POA”) electrically connected to the set terminal of the VFO 32 and a second potentiometer terminal (labelled “POB”) electrically connected to supply voltage terminal of the VFO. The set terminal of the VFO 32 may alternatively be electrically connected to a third potentiometer (or wiper) terminal (labelled “POW”).

The digital potentiometer 42 includes a ground terminal (labelled “VSS”) electrically connected to ground.

The digital potentiometer 42 includes a serial data terminal (labelled “SDA”) and a serial clock terminal (labelled “SCL”).

An MCU 44 provides command data to the digital potentiometer 42 using an I²C protocol. The command data selectively varies the resistance of the digital potentiometer 42 and hence the value of Rₛₑₜ that is applied to the VFO 32. The MCU 44 also provides clock data. The communication protocol is not limited to I²C and other suitable serial protocols (e.g., SPI or UART) or parallel protocols may be used instead.

The MCU 44 may use an appropriate control scheme to generate the command date for increasing or decreasing the resistance of the digital potentiometer 42. The MCU 44 selectively varies the resistance of the digital potentiometer 42 based on an estimated or determined impedance value of the parallel RLC circuit, which is indicative of a change in the resonant frequency.

The controller 12B includes a voltage sensor 46 and a current sensor 48 which provide voltage and current measurements, respectively. The voltage measurements are provided to a first low pass filter 50 and the current measurements are provided to a second low pass filter 52. Unfiltered voltage and current measurements are provided directly to the MCU 44 where they may be used for high-speed protective monitoring to prevent overheating of the aerosol generating material, for example. The first low pass filter 50 and the second low pass filter 52 may output the filtered (or averaged) voltage and current measurements which may simplify the impedance calculation of the oscillating circuit.

The filtered voltage and current measurements are provided to a divider (or a multiplier/divider) 54. The divider 54 includes a first input terminal (labelled “X1”), a second input terminal (labelled “X2”), a third input terminal (labelled “Z1”), a fourth input terminal (labelled “Z2”) and an output terminal (labelled “W”). The second and third input terminals are electrically connected to ground. The first input terminal is electrically connected to the second low pass filter 52 and receives the filtered current measurements from the current sensor 48. The fourth input terminal is electrically connected to the first low pass filter 50 and receives the filtered voltage measurements from the voltage sensor 46. The divider 54 uses the filtered voltage and current measurements to estimate or determine an impedance value of the parallel RLC circuit. More particularly, the output signal which is indicative of the impedance value is determined by:

$$W = \frac{{Z}_{2} - {Z}_{1}}{{X}_{1} - {X}_{2}}$$

The divider 54 may calculate the impedance value of the oscillating circuit 36 instead of the MCU 44. This may result in faster calculation of the impedance value.

The output signal from the output terminal of the divider 54 and a trim signal (Vₜᵣᵢₘ) are provided to an operational amplifier 56. The output signal from the operational amplifier 56 is provided to the MCU 44. The output signal from the divider 54 corresponds to the background value of the calculated impedance value. By trimming the background value and amplifying the remaining impedance value, the resolution of the impedance value may be improved.

An increase in the impedance value of the parallel RLC circuit will normally indicate an increase in the resonant frequency and vice versa. The MCU 44 uses an appropriate control scheme to determine if the output signal from the operational amplifier 54 indicates that the resonant frequency of the parallel RLC circuit is increasing or decreasing. If the MCU 44 determines that the resonant frequency is increasing, it will control the digital potentiometer 42 to decrease its resistance by an appropriate amount. The external resistance Rₛₑₜ will therefore decrease and the oscillator frequency f_{osc} will increase. On the other hand, if the MCU 44 determines that the resonant frequency is decreasing, it will control the digital potentiometer 42 to increase its resistance by an appropriate amount. The external resistance Rₛₑₜ will therefore increase and the oscillator frequency f_{osc} will decrease. By changing the resistance of the digital potentiometer 42, the MCU 44 may make the oscillator frequency track the resonant frequency of the parallel RLC circuit. The digital potentiometer 42 may be controlled so that the change in the oscillator frequency f_{osc} as a result of the change in its resistance substantially matches the change in the resonant frequency of the parallel RLC circuit, i.e., so that the oscillator frequency and the resonant frequency remain substantially matched even when the temperature of the susceptor(s) 20 changes.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments. For example, instead of the parallel RLC circuit mentioned above, a series parallel RLC circuit may be used.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating device comprising:
a power source;
an oscillating circuit configured to generate a time varying electromagnetic field for inductively heating a susceptor; and
a frequency generating circuit comprising:
a variable frequency oscillator VFO comprising:
a supply voltage terminal configured to receive a supply voltage;
a set terminal; and
an oscillator output terminal configured to provide an output signal having a frequency that is determined by an input signal into the set terminal;
a switching circuit electrically connected to the power source and configured to drive the oscillating circuit at an operating frequency determined by the frequency of the output signal of the VFO; and
a variable resistive component electrically connected to the set terminal of the VFO.

2. An aerosol generating device according to claim 1, further comprising a voltage regulator electrically connected to the power source and including a voltage regulator output terminal configured to provide a regulated supply voltage, wherein the supply voltage terminal of the VFO is electrically connected to the voltage regulator output terminal.

3. An aerosol generating device according to claim 1, wherein the variable resistive component is a thermistor having an internal resistance that varies with temperature.

4. An aerosol generating device according to claim 3, further comprising a heating chamber or an aerosol generating space, and wherein the thermistor is mounted on a surface of the heating chamber or aerosol generating space.

5. An aerosol generating device according to claim 1, further comprising a control unit, and wherein the variable resistive component is a digital potentiometer having a resistance that is selectively varied by the control unit.

6. An aerosol generating device according to claim 5, wherein the digital potentiometer comprises a first potentiometer terminal electrically connected to the set terminal of the VFO, a second potentiometer terminal electrically connected to the supply voltage terminal of the VFO, and a data terminal configured to receive command data from the control unit for selectively varying the resistance of the digital potentiometer.

7. An aerosol generating device according to claim 5, wherein the control unit is configured to vary the resistance of the digital potentiometer based on an estimated or determined impedance value of the oscillating circuit.

8. An aerosol generating device according to claim 7, further comprising a voltage sensor configured to provide voltage measurements and a current sensor configured to provide current measurements, wherein the voltage and current measurements are used to estimate or determine the impedance value of the oscillating circuit.

9. An aerosol generating device according to claim 8, further comprising a divider configured to receive the voltage and current measurements provided by the voltage and current sensors and to output an impedance value to the control unit that is determined using the voltage and current measurements.

10. An aerosol generating device according to claim 9, further comprising a first low pass filter connected between the voltage sensor and the divider.

11. An aerosol generating device according to claim 9, further comprising a second low pass filter connected between the current sensor and the divider.

12. An aerosol generating device according to claim 1, wherein the switching circuit is an inverter.

13. An aerosol generating system for generating an aerosol for inhalation by a user, the system comprising an aerosol generating device according to claim 1, and an aerosol generating article comprising a susceptor and aerosol generating material.

14. A method for controlling the heating of a susceptor of an aerosol generating system for generating an aerosol for inhalation by a user, the system comprising:
a power source;
an oscillating circuit configured to generate a time varying electromagnetic field for inductively heating the susceptor; and
a frequency generating circuit comprising a VFO, a switching circuit electrically connected to the power source, and a variable resistive component;
the method comprising controlling the VFO to provide an output signal having a frequency that is determined by the resistance of the variable resistance component and driving the oscillating circuit at an operating frequency determined by the frequency of the output signal of the VFO.

15. A method according to claim 14, wherein the variable resistive component is a thermistor having an internal resistance that varies with temperature or a digital potentiometer having a resistance that is selectively varied.
